(19) United States
(12) Patent Application Publication
(10) Pub. No.: US 2007/0233446 A1
(43) Pub. Date: Oct. 4, 2007

(54) Feedback simulation method applicable to air-conditioning system

(76) Inventor: Hui Jiunn Chen, Taipei (TW)

Correspondence Address: TROXELL LAW OFFICE PLLC, SUITE 1404, 5205 LEESBURG PIKE, FALLS CHURCH, VA, 22041, US

(21) Appl. No.: 11/637,890

(22) Filed: Dec. 13, 2006

(30) Foreign Application Priority Data
Mar. 29, 2006 (TW) 095110822

(51) Int. Cl. G06F 17/50

(52) U.S. Cl. 703/14

(57) ABSTRACT

In a feedback simulation method applicable to air-conditioning system, an error signal is fed back when a non-acceptable difference between a simulation value and a required value is found; modification procedures are conducted in response to the error signal and according to system modification criteria to adjust control direction and modify initial parameters for input in next simulation. The feedback and modification are repeated until the system momentum balancing and energy balancing is reached.

### FIELD OF THE INVENTION

The present invention relates to a feedback simulation method applicable to air-conditioning system, in which initial parameters are input, a simulation model is established, limiting conditions are set, a simulation theory based on laws of conservation of mass, momentum, and energy is built, an error between a simulation value and a required value is determined, modification procedures including pressure balancing and energy balancing are conducted, and load parameter is changed in simulation conducted at a subsequent time point, so as to output simulation results. With the analyzing mode in the feedback simulation method, it is able to get the system running condition at system expansion or system load change, enabling a designer to know the actual system operation just in the design phase and to propose an effective operation strategy based on an energy-saving basis.

### BACKGROUND OF THE INVENTION

Different air-conditioning system design methods, such as T-Method and Dynamic Programming Method, have been employed to achieve optimized design and apparatus size/specification determination for refrigeration and air-conditioning systems. In actual running process, there are times the air conditioning load changes and the system operates at partial load. However, the above-mentioned methods fail to provide effective solutions for balance adjustment and energy-saving control that are needed when the system operates at partial load. It is therefore tried by the inventor to develop a new method, namely, feedback simulation method, to overcome the problem existed in the conventional air-conditioning system design methods.

There are other simulation methods used to analyze the design of air-conditioning system. One example of these simulation methods is the open-loop simulation method, a flowchart of which is illustrated in FIG. 1. The open-loop simulation method is a one-way forward method, which has the advantages of fewer steps, simple process, and less time-consuming. However, the open-loop simulation method provides relatively simple simulation without a feedback and modification function. As a result, the open-loop simulation method is only suitable for rather simple systems but not the highly complicate refrigeration and air-conditioning systems.

### SUMMARY OF THE INVENTION

A primary object of the present invention is to provide a feedback simulation method applicable to air-conditioning system, so that simulation may be conducted on a design-phase system to help in understanding of an actual running condition of the system and analyses may be conducted according to simulation results, in order to minimize drawbacks in the system design and increase the flexibility of the system design to enable effective energy-saving running strategy.

To achieve the above and other objects, the feedback simulation method applicable to air-conditioning system according to the present invention includes the following steps: (1) inputting related system parameters; (2) using an existing air-conditioning system design method to proceed with system size design based on the input parameters; (3) conducting system simulation on the design-phase system in a simulation mode that is established in adherence to the laws of conservation of mass, momentum, and energy, and includes different physical and mathematical models depending on system features; (4) comparing a simulation value and a required value, and feeding back an error signal when a difference between the two values is found as non-acceptable; (5) conducting modification procedures in response to the error signal and according to system modification guideline, so as to adjust the control function of control valves to reach balanced operation conditions for the system and derive the power consumption of all parts in the system; and (6) conducting modification procedures to modify initial load parameter when the system simulation is to be conducted at a subsequent time point. The feedback and modification are repeated until system momentum balance and energy balance are reached, and the simulation results are output.

The feedback simulation method of the present invention may also be used in analysis of energy-saving effects obtained from system running at different control strategies, so as to derive an optimized energy-saving control mode. With the analysis mode of the feedback simulation method, it is possible to get a concrete ideal about the running state of the system when the system is expanded or the system load is changed, so that the designer may well understand the actual system running condition in the design phase.

The feedback simulation method of the present invention may also be conducted on an already constructed system to analyze the running thereof under different control strategies, so as to propose an effective energy-saving running strategy.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flowchart showing the steps included in the conventional open-loop simulation method;

FIG. 2 is a flowchart showing the steps included in the feedback simulation method according to the present invention;

FIG. 3 shows an acid gas process exhaust system, on which the present invention may be implemented;

FIG. 4a is a conceptual view showing a pipe system reduced from two serially connected pipes;

FIG. 4b is a conceptual view showing a pipe system reduced from two parallelly connected pipes; and

FIG. 4c is a conceptual view showing a pipe system reduced from three T-connected pipes.

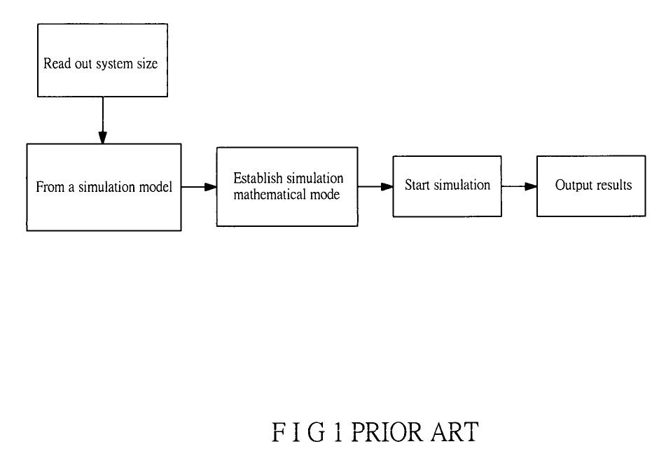

### DETAILED DESCRIPTION OF THE PREFERRED EMBODIMENTS

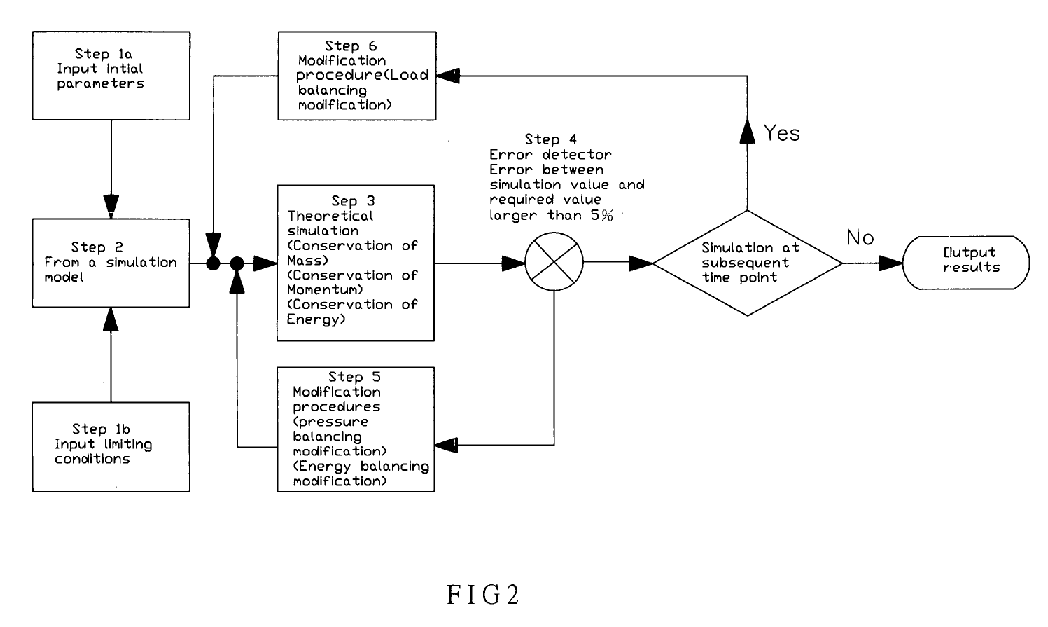

Please refer to FIG. 2 that is a flowchart showing analyzing steps included in the feedback simulation method according to the present invention.

First, relevant system parameters for a simulation model are input. More specifically, initial parameters and limiting conditions for a simulation model are input in Step 1a and Step 1b, respectively.

When the relevant system parameters are known from Steps 1a, 1b, an existing air-conditioning system design method is used to do system size design in Step 2.

Then, in Step 3, system simulation is conducted on the system designed in the Step 2. Depending on the features of different systems, the simulation mode adopted in the Step 3 may include different physical and mathematical models. Moreover, the simulation mode is established in adherence to the laws of conservation of mass, momentum, and energy.

In Step 4, when a difference is found between a system simulation value and a required value, and the difference exceeds a preset range, an error signal is fed back.

In Step 5, modification procedures are conducted in response to the error signal to generate new system simulation input values. The modification procedures are repeated until the difference between the simulation value and the required value falls in an acceptable tolerance range to satisfy the above-mentioned three laws of conservation. Then, the simulation is completed. The modification procedures are deduced according to the requirements of the air-conditioning system for use in modifying the system, and include, for example, adjusting of damper angle to achieve pressure balancing, and changing of pump rotation speed to achieve energy balancing. In the present invention, modification criteria are established according to system features. Through amendment of the modification criteria, time required for the simulation may be effectively reduced and the system designed and constructed through feedback simulation method is more accurate.

The modification procedures in the Step 5 include pressure balancing and energy balancing. The pressure balancing modification procedure is conducted because all paths in the system should have balanced pressure. Here, by “pressure balancing”, it means all the paths in the system have the same total pressure loss. In an air-conditioning system, paths with unbalanced total pressure loss would result in low flow in the paths that does not meet the design requirement. Therefore, flow balancing devices, such as dampers or balance valves, are mounted at terminal path that has smaller total pressure drop, so as to increase a resistance in the path. Then, the mounted flow balancing devices may be adjusted to reach pressure balancing. In the energy balancing modification procedure, a flow demand is derived from the required load of each heat exchanger in the system, and the rotation speed of frequency converter pump is regulated using two-way or three-way valves under control, so that the energy balancing required by all loads can be reached.

In a final Step 6 of the feedback simulation method, the system load parameter is changed. In a refrigeration and air-conditioning system, system load varies with time. When the simulation of system state at the same time point is repeated, it is no need to change the system load parameter. On the other hand, when the simulation at a certain time point is ended and it is desired to simulate the system state at a subsequent time point, the system load parameter must be changed and input again before the simulation can be started.

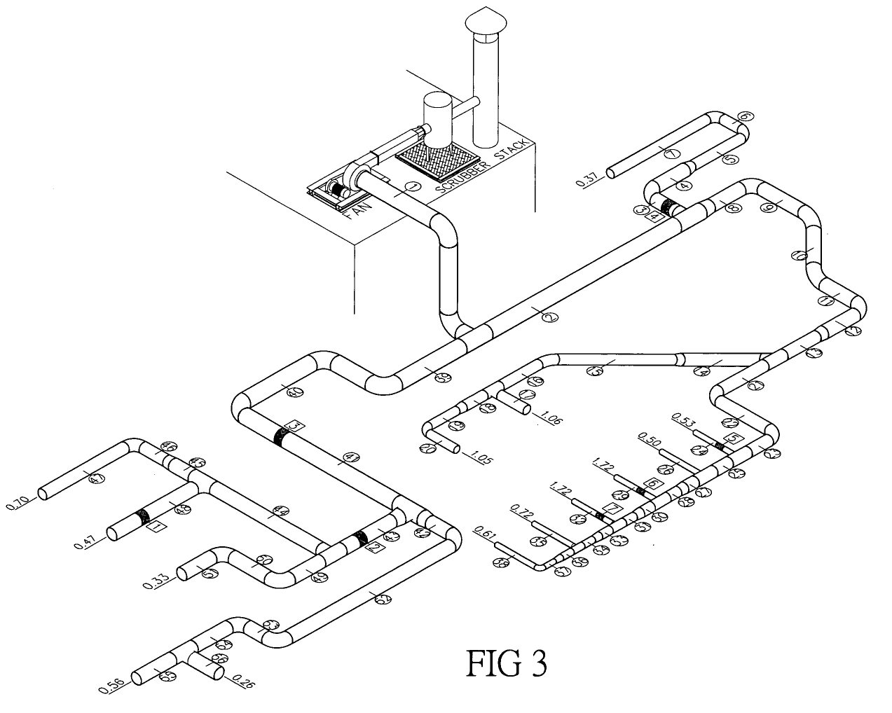

The feedback simulation method of the present invention may be used in analyzing a design-phase system, so as to simulate the rating in actual running process of the system. The feedback simulation method conducted on an acid gas process exhaust system shown in FIG. 3 will now be recited as an example of the present invention. Please refer to FIGS. 2 and 3 at the same time. In the Steps 1a and 1b, initial parameters and limiting conditions are input. The initial parameters include the properties of working fluid, the geometrical properties and allocation of air ducts, the properties of fluid, and the air flow in each pipe. The limiting conditions include the safe flow rate or the high and low limits for pipe diameter. In the Step 2, the process exhaust system is designed using an existing air duct design method and based on the parameters and conditions input in the Step 1a, 1b, so as to derive the diameter for each pipe, and determine the desired air duct specification. In the Step 3, the length of each pipe and the fan performance curve are input one by one, so as to establish a simulation theory. The air duct simulation theory adopted in the feedback simulation method includes three major parts, namely, system reduction, fan operating point determination, and system development.

In the part of system reduction, a complicate pipe system is so reduced that it is represented only by a virtual pipe, and then, an equivalent flow conductance coefficient for the virtual pipe is derived. The total pressure drop across an air duct may be expressed as below using the Darcy-Weisbach Formula:

$$Δ {P}_{t} = ( \frac{fL}{D} + \sum C ) \cdot \frac{8 ρ}{{π}^{2}} \cdot {Q}^{2} {D}^{- 4} \\ Given that \\ μ = ( \frac{fL}{D} + \sum C ) \cdot D \qquad ( 1 )$$

Then the relation between volume flow and pressure loss may be expressed as below:

$$Q = \frac{π}{\sqrt{8}} {( \frac{{D}^{5}}{μρ} )}^{0.5} \cdot \sqrt{Δ {P}_{t}} \qquad ( 2 )$$

Further given that a flow conductance coefficient is

$${K}_{s} = \frac{π}{\sqrt{8}} {( \frac{{D}^{5}}{μρ} )}^{0.5}$$

Then the formula (2) may be expressed as below:

Q=Kₛ\sqrt{ΔPₜ} (3)

With the formula (3), the system reduction may begin. No matter how complicate a pipe system is, pipes in the system are always connected in one of the following three manners: connection in series, connection in parallel, and T-connection. The system reduction for these three different pipe systems will now be described.

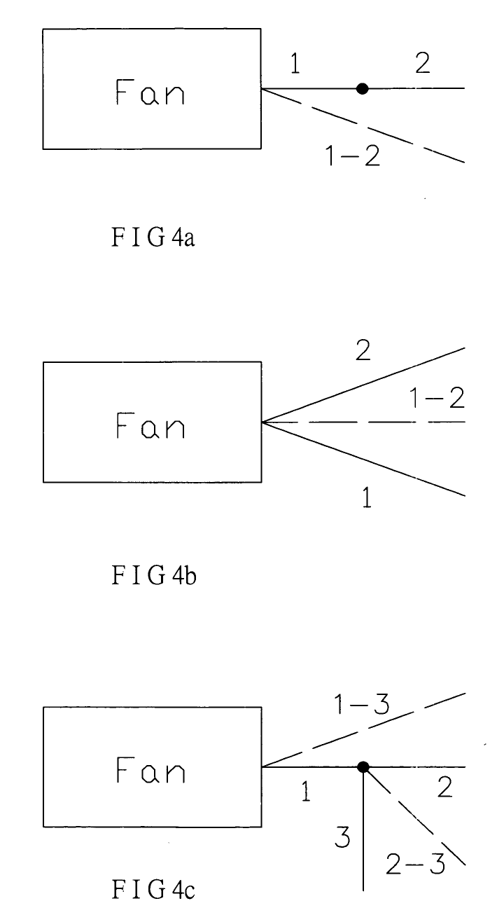

Please refer to FIG. 4a that shows a pipe system consisting of two serially connected pipes 1, 2. To reduce the serially connected pipes 1, 2 into one single virtual pipe 1-2, the virtual pipe 1-2 must satisfy the following limiting conditions:

The conservation of air flow and the conservation of pressure are expressed by the following formulas (4) and (5), respectively:

Q₁₋₂=Q₁=Q₂ (4)

ΔP₁₋₂=ΔP₁+ΔP₂ (5)

Now, substitute formula (3) into formula (4) to derive:

$$\frac{{Q}_{1 - 2}^{2}}{{K}_{{s}_{1 - 2}}^{2}} = \frac{{Q}_{1}^{2}}{{K}_{{s}_{1}}^{2}} + \frac{{Q}_{2}^{2}}{{K}_{{s}_{2}}^{2}} \qquad ( 6 )$$

Then, substitute formula (4) into formula (6) to derive the equivalent flow conductance Kₛ₁₋₂ for the virtual pipe 1-2 of the serially connected pipes 1, 2 as follows:

Kₛ_{₁₋₂}=(Kₛ_{₁}⁻²+Kₛ_{₂}⁻²)^{-0.5} (7)

Please refer to FIG. 4b that shows a pipe system consisting of two parallelly connected pipes 1, 2. To reduce the parallelly connected pipes 1, 2 into one single virtual pipe 1-2, the virtual pipe 1-2 must satisfy the following limiting conditions:

Q₁₋₂=Q₁+Q₂ (8)

ΔP₁₋₂=ΔP₁=ΔP₂ (9)

From formula (3) and formula (8), the equivalent flow conductance coefficient for the virtual pipe 1-2 of the parallelly connected pipes 1, 2 is obtained as follows:

Kₛ_{₁₋₂}=Kₛ_{₁}+Kₛ_{₂} (10)

Please refer to FIG. 4c that shows a pipe system consisting of three T-connected or Y-connected pipes 1, 2, and 3. To reduce the three T-connected or Y-connected pipes 1, 2, and 3 into one single virtual pipe 1-3, the pipes 2 and 3 are considered as having been parallelly connected and then further serially connected to the pipe 1. Then, the equivalent flow conductance coefficient for the reduced virtual pipe 1-3 is expressed as follows:

Kₛ_{₁₋₃}=[Kₛ_{₁}⁻²+(Kₛ_{₂}+Kₛ_{₃})⁻²]^{-0.5} (11)

When the system reduction is completed, the complicate system is simplified to include only a fan and one single virtual pipe. The flow conductance coefficient for the virtual pipe is K_{sys}, and the relation between the air flow and the pressure drop of the system is expressed as follows:

Q_{sys}=K_{sys}\sqrt{ΔP_{sys}} (12)

The formula (12) represents an impedance curve of the system. A fan operating point can be derived from an intersect of the system impedance curve with a fan performance curve, and the total pressure P_{fan} and air flow Q_{fan} provided by the fan during operation thereof may be further obtained. When the fan operating point has been determined, the system development may begin to develop the previously reduced system, and allocate the air flow to each pipe according to the equivalent flow conductance coefficient K_{sys} of the pipe. The allocation of air flow is calculated in steps reverse to that for calculating the system reduction. After completion of the above-mentioned three major parts, namely, system reduction, fan operating point determination, and system development, system simulation is conducted in the Step 3. In the Step 4, the simulation value and the required value are compared. The error between the two values must fall in the range between 0 and 5%. When the error is larger than 5% or smaller than zero, modification procedures are conducted in the Step 5.

The modification procedures in the Step 5 are established based on the condition of total pressure balancing. Given that there are N paths in a certain exhaust system, and the required air flows of these paths are Q₁, Q₂, . . . Q_{N}. Then, the required system total air flow Q_{sys} is:

$${Q}_{sys} = {\sum }_{n = 1}^{n = N} {Q}_{n} \qquad ( 13 )$$

Given that the total pressure losses of the paths caused by pipes and valves are:

ΔP_{D,1},ΔP_{D,2} . . . ,ΔP_{D,N}

And, the pressure losses of the paths caused by damper opening are:

ΔP_{D,1},ΔP_{D,2} . . . ,ΔP_{D,N}

Then, the total pressure loss of all the paths is:

ΔPₙ=ΔP_{T,n}+ΔP_{D,n}, where n=1, 2, . . . N (14)

Since the air flow provided by the fan in the exhaust system must satisfy the total air flow needed by all the paths, the total air flow to be provided by the fan during operation thereof is:

$${Q}_{fan} = {Q}_{sys} = {\sum }_{n = 1}^{n = N} {Q}_{n} \qquad ( 15 )$$

Further, since the air flow provided by the fan during operation thereof is known, the fan operating point under this operation condition may be obtained from the fan performance curve. From the above, it may be found the total pressure provided by the fan during operation thereof is P_{fan}, and the pressure obtained by each path is also P_{fan}:

P_{fan}=ΔPₙ (16)

When the condition of total pressure balancing at all paths has been satisfied, a sum of the total pressure loss of all paths and the pressure loss caused by damper opening must be equal to the total pressure provided by the fan. That is:

P_{fan}=ΔP_{T,n}+ΔP_{D,n} (17)

The relation between the pressure loss caused by damper opening in the paths and the partial loss factor Cᵥ thereof may be expressed by:

Cᵥ=Qₙ/\sqrt{ΔP_{D,n}} (18)

When the formula (17) is substituted into the formula (18), the damper partial loss factor of each path can be derived and used for adjusting the damper opening angle. Then, the process goes back to the Step 3 to conduct next system simulation, and the analysis of the process exhaust system load using the feedback simulation method continues until the error value is lowered to fall in the acceptable range.

Finally, in the Step 6, modification procedures are conducted to modify the process exhaust system load parameter. The system simulation in the Step 3 and the modification procedures in the Step 6 are repeated until the analysis of all possible changes in system load has been completed. Then, the simulation results are output.

The feedback simulation method may be used to analyze the actual running condition of a design-phase system, or to analyze the running of a fully constructed system under different control strategies and propose an effective energy-saving operation strategy. The feedback simulation method of the present invention may be applied to air-conditioning systems, including air system, water system, and ice storage system, and is therefore highly valuable in industrial fields.

What is claimed is:

1. A feedback simulation method applicable to air-conditioning system, comprising the following steps:
Step 1: inputting initial parameters that involve basic properties of a simulation model and include at least fluid to be simulated, material of pipes being used in the simulation model; inputting a layout of the simulation model; and inputting limiting conditions in connection with the simulation model;
Step 2: starting an initial system design, in which an existing air-conditioning system design method is used to do system size design;
Step 3: conducting system simulation on a system designed in the Step 2 based on the parameters and limiting conditions input in the Step 1, wherein a simulation mode adopted in the system simulation includes different physical and mathematical models, depending on different system features, and the simulation mode is established in adherence to laws of conservations of mass, momentum, and energy;
Step 4: determining an error between a simulation value and a required value;
Step 5: conducting system modification procedures when the error determined in the Step 4 falls in a non-acceptable range; and
Step 6: changing system load parameter based on a fact that system load varies with time in a refrigeration and air-conditioning system; wherein when a system state at the same time point is simulated, the system load parameter need not be changed, and wherein when a system state at a subsequent time point is to be simulated, the system load parameter at that time point must be changed and input before the system simulation can be started.

2. The feedback simulation method applicable to air-conditioning system as claimed in claim 1, wherein, in the Step 5, an error signal is fed back when the error between the simulation value and the required value as obtained in the system simulation in the Step 3 exceeds a preset range, and the modification procedures in the Step 5 are repeated in response to the error signal to adjust the system simulation input values for next simulation until the error falls in an acceptable range; and wherein the modification procedures are deduced according to requirements of an air-conditioning system and may include adjustment of damper angle to achieve pressure balancing and change of pump rotation speed to achieve energy balancing, depending on different system conditions.

3. The feedback simulation method applicable to air-conditioning system as claimed in claim 2, wherein, in the Step 5, the modification procedures are conducted by following modification criteria established according to system features, so as to effectively reduce time required for the simulation and enable an increased system accuracy.

4. The feedback simulation method applicable to air-conditioning system as claimed in claim 1, wherein, in the Step 5, the modification procedures include pressure balancing and energy balancing.

5. The feedback simulation method applicable to air-conditioning system as claimed in claim 4, wherein the pressure balancing modification procedure is conducted based on facts that all paths in the air-conditioning system should have balanced pressure, and that the pressure balancing means all the paths in the system have the same total pressure loss.

6. The feedback simulation method applicable to air-conditioning system as claimed in claim 4, wherein, in the energy balancing modification procedure, a flow demand is derived from a required load of each heat exchanger in the system, and a rotation speed of a frequency converter pump in the system is regulated using two-way or three-way valves under control, so that the required energy balancing of each load is reached.
